(19) United States
(12) Patent Application Publication
(10) Pub. No.: US 2005/0162337 A1
(43) Pub. Date: Jul. 28, 2005

(54) Display device and a method of controlling the same

(76) Inventors: Toshiaki Ohashi, Fujisawa (JP); Yasuhiro Tomita, Odawar (JP); Hideki Hashimoto, Hadano (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 10/838,189

(22) Filed: May 5, 2004

(30) Foreign Application Priority Data
May 12, 2003 (JP) 2003-132467

(51) Int. Cl. G09G 5/00

(52) U.S. Cl. 345/1.1

(57) ABSTRACT

A display device and a method of controlling the same are disclosed. A liquid crystal TV set or a plasma TV set having multiple display functions including PC monitor and TV display comprises a video signal synthesizer synthesizing PC video signal and TV video signal on a frame memory in a way not to superpose the screens. A PC screen (large picture) and TV screens (small pictures) are displayed in tiles. A dynamic image of TV video signal is displayed in one of plural small pictures, and a still image of TV video signal is displayed in another small picture thereby to display plural TV video channels concurrently. Consequently, a part of a PC monitor screen (large picture) is not concealed behind TV display screens (small pictures), thereby preventing workability of a spreadsheet work and a document composition work on the PC screen from being deteriorated.

### INCORPORATION BY REFERENCE

The present application claims priority from Japanese application JP 2003-132467 filed on May 12, 2003, the content of which is hereby incorporated by reference into this application.

### BACKGROUND OF THE INVENTION

The present invention relates to a display device for displaying a PC video signal (RGB signals) output from a personal computer (hereinafter referred to as “PC”) and a TV video signal (NTSC signal, etc.) for television broadcast, or in particular to a display device suitable for displaying the PC video signal and the TV video signal on the same screen at the same time.

The conventional method shown in FIGS. 11A and 11B is known, in which a plurality of television broadcast programs are displayed at the same time on the screen of a television receiver (hereinafter referred to as “TV receiver”). The method of FIG. 11A is what is called the picture-in-picture method, in which one TV broadcast program is displayed as a background screen over the entire picture plane of the TV receiver and another TV broadcast program is displayed as a windows by being superposed on the background picture. In this way, the user can watch two different TV broadcast programs at the same time.

With the recent extension of home PC ownership, demand has arisen for a home display device which functions as both a TV receiver and a PC monitor at the same time. To meet this demand, some models of the liquid crystal TV set and plasma TV set are available which are equipped with an input terminal for the PC video signal (RGB signals) output from the PC to make it possible to display the PC video signal output from the PC as what is called the PC monitor function.

For the TV receiver having the PC monitor function to display the TV video signal of TV broadcast and the PC video signal output from the PC at the same time, the picture-in-picture display method is known in which the PC monitor screen for displaying the PC video signal output from the PC is used as large picture and the TV screen for displaying the TV video signal for the TV broadcast is used as a windows.

Further, some picture-in-picture display methods are known to have the function to change the display position of the TV screen (windows) by remote control operation of the TV receiver.

In the case where the PC monitor doubles as a TV receiver, the user can advantageously view the TV broadcast program on the TV screen (small pictures) even while conducting the spreadsheet job or the document composition work on the PC screen by operating the mouse or the keyboard of the PC.

With a wide monitor having an aspect ratio of 16:9, on the other hand, a technique is known to display a TV broadcast video signal having an aspect ratio of 4:3 on the left side of the screen and a data broadcast program on the right side thereof during the blanking period of the TV broadcast video signal in a manner not to be superposed one on the other, as disclosed in JP-A-9-18801.

### SUMMARY OF THE INVENTION

In the conventional picture-in-picture display method for the TV receiver such as a liquid crystal TV set or a plasma TV set having the PC monitor function described above, the TV screen (small picture) is displayed in superposition on the PC monitor screen (large picture). In the conventional method of using the TV receiver as a PC monitor at the same time, the user conducting the spreadsheet job or the document composition work on the PC screen by mouse or keyboard operation of the PC encounters the serious problem that part of the PC monitor screen (large picture) is hidden behind the TV screen (large picture) and the workability of the spreadsheet job or the document composition on the PC screen is extremely deteriorated.

In order to solve this problem, a object of the invention is to provide a display device for displaying a PC video signal and a TV video signal at the same time, comprising a frame memory for storing display information corresponding to resolution of the display device, a scaling unit for changing the resolution of the TV video signal, and a video signal synthesis unit for recording the PC video signal, the PC display information corresponding to the scaled TV video signal and the TV video signal in an area free of superposition in the frame memory, wherein the PC video signal and the TV video signal are displayed in tiles.

Further, according to the invention, there is provided a display device wherein a plurality of TV video signal recording areas are formed without superposition in the frame memory, TV channel information to be displayed is determined in advance for each of the plurality of the areas, and TV video information in one of the areas is displayed as a dynamic image based on the TV channel information. At the same time, still images of the TV video information in the other areas may be displayed. The area in which the dynamic image is displayed is selected from operation information input by a remote controller which operates a display device or may be selected at a predetermined timing.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing the system configuration of a display device according to this invention.

FIGS. 2A and 2B are schematic diagrams showing a write operation of the frame memory.

FIG. 3 is a display illustration showing a PC screen.

FIG. 4 is an illustration showing a display of multiple screens including a PC large picture and TV small pictures.

FIG. 5 is a diagram for explaining the display of TV small pictures in display mode 1.

FIGS. 6A-6E are diagrams for explaining the display of TV small pictures in display mode 2.

FIGS. 7A-7D are diagrams for explaining the display of TV small pictures in display mode 3.

FIG. 8 is a diagram for explaining the display of TV small pictures in display mode 4.

FIG. 9 is a diagram for explaining the display of TV small pictures in display mode 5.

FIG. 10 is a diagram showing the system configuration of a display device according to another embodiment of the invention.

FIGS. 11A and 11B are illustrations of the conventional picture-in-picture display screens.

FIG. 12 is an illustration showing a multi-tile display of a PC large picture and TV small pictures according to this invention.

FIG. 13 is a schematic diagram showing a remote controller.

FIG. 14 is a flowchart showing a control operation in display mode 1.

FIG. 15 is a flowchart showing a control operation in display mode 2.

FIG. 16 is a flowchart showing a control operation in display mode 3.

FIG. 17 is a flowchart showing a control operation in display mode 4.

FIG. 18 is a flowchart showing a control operation in display mode 5.

### DESCRIPTION OF THE EMBODIMENTS

Embodiments of the invention are explained in detail below with reference to the accompanying drawings.

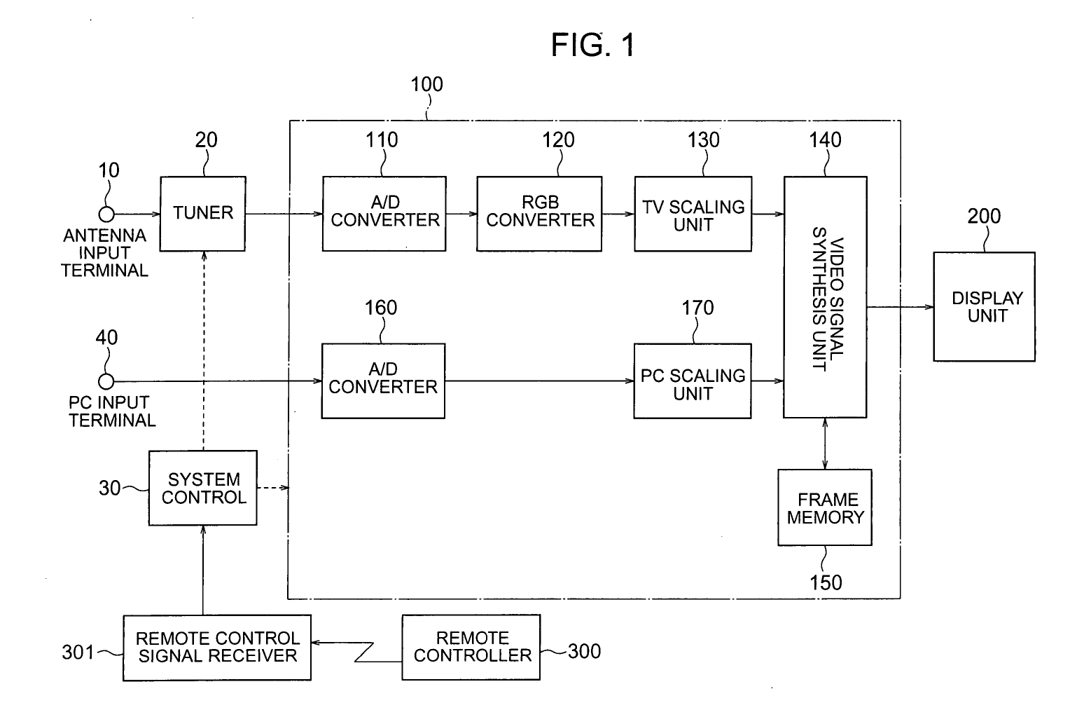

FIG. 1 is a block diagram showing a display device according to a first embodiment of the invention. The display device according to the embodiment shown in FIG. 1 has the function of receiving a TV broadcast signal and displaying a TV video signal, the function of displaying a PC video signal output from the PC and the function of displaying the PC video signal and the TV video signal at the same time without mutual superposition.

The type and the resolution of the video signal display device shown in FIG. 1 are not specifically limited and any display device such as a CRT, the liquid crystal panel or the plasma display panel may be employed. This embodiment is explained, however, with reference to a case using a liquid crystal panel having a resolution of what is called WXGA with 1280 horizontal pixels and 768 vertical pixels. A display unit 200 shown in FIG. 1, therefore, is assumed to be configured of a liquid crystal panel having the resolution of what is called WXGA.

First, explanation is given of a case in which a TV broadcast signal is received and a TV video signal of a TV broadcast program selected by the user is displayed over the whole screen of the display unit 200 of the display device according to this embodiment.

An antenna for receiving the TV broadcast radio wave is connected to an antenna input terminal 10 shown in FIG. 1, and the TV broadcast radio wave is input to a tuner 20 through the antenna input terminal 10. The user operates a remote controller 300 to control the display device and gives an instruction to select a predetermined TV broadcast program (channel). Then, a tuning instruction signal is input through a remote control signal receiving unit 301 to a system control unit 30 configured of a microcomputer or the like for controlling the whole display device. Further, the tuner 20, in response to an instruction from the system control unit 30, selects and receives a predetermined TV broadcast program (channel) and outputs the TV video signal (NTSC signal, for example) of the selected TV broadcast program.

According to this embodiment, the format of the TV video signal is not specifically limited, and the NTSC signal is taken as an example of the TV video signal in the description that follows.

The TV video signal selectively received by and output from the tuner 20 is applied to an A/D converter 110 in a video signal processing unit 100. The A/D converter 110 converts the input TV video signal in analog form to a digital signal at a predetermined sampling frequency. In the case where the TV video signal is the NTSC signal, the sampling frequency is set to 768 horizontal effective pixels per horizontal scanning line (hereinafter simply referred to as “per line”). Incidentally, the number of the vertical effective lines for the NTSC signal is 485 per frame. Therefore, the A/D converter 110 outputs a digital TV video signal having 768 horizontal effective pixels per line and 485 vertical effective lines per frame.

The digital TV video signal into which the analog signal is converted by the A/D converter 110 is applied to a RGB converter 120. The RGB converter 120 converts the digital TV video signal (NTSC signal) into digital RGB signals.

As described above, the display unit 200 shown in FIG. 1 is configured of a CRT, a liquid crystal panel, a plasma display panel, etc. The input signal to a display device, however, generally assumes the form of the RGB signals. For the TV video signal to be displayed on the display unit 200, therefore, the digital TV video signal is required to be converted into digital RGB signals. The RGB converter 120, which is configured of what is called a matrix circuit or the like, operates to generate the digital RGB signals for the display unit 200 from the input digital TV video signal (NTSC signal), and the digital RGB signals thus converted for the TV system are output to a TV scaling unit 130.

The TV scaling unit 130, in order to display the input TV digital RGB signals in a predetermined image size on the display unit 200, operates to expand or compress the horizontal and vertical image sizes of the input TV digital RGB signals. In the case where the TV video signal is the NTSC signal, as described above, the TV digital RGB signals input to the TV scaling unit 130 have an image size of 768 horizontal effective pixels per line and 485 vertical effective lines per frame. In the case where the display unit 200 is a liquid crystal panel of WXGA, on the other hand, the resolution of the display unit 200 is 1280 horizontal pixels and 768 vertical lines, thereby causing an image size mismatch between the TV digital RGB signals and the display unit 200.

In the case where the TV broadcast signal is received and the TV video signal of a TV broadcast program selected by the user is displayed over the whole screen of the display unit 200, the TV scaling unit 130 so operates that the TV digital RGB signals having the image size of 768 horizontal effective pixels per line and 485 vertical effective lines per frame of the display unit 200 are horizontally and vertically expanded to the TV digital RGB signals having 1280 horizontal effective pixels per line and 768 vertical effective lines per frame coincident with the resolution of 1280 horizontal pixels and 768 vertical lines of the display unit 200. This magnification is given as an instruction to the TV scaling unit 130 from the system control unit 30 for controlling the display device as a whole.

The TV digital RGB signals (1280 horizontal effective pixels per line and 768 vertical effective lines per frame) expanded to the same resolution as the display unit 200 by the TV scaling unit 130 are applied to a memory frame 150 through a video signal synthesis unit 140.

The video signal synthesis unit 140 is for synthesizing the TV video signal and the PC video signal to be displayed on the same screen at the same time, and described in detail later. In the case where the TV broadcast signal is received and the TV video signal of the TV broadcast program selected by the user is displayed over the whole screen of the display unit 200, there is no special need to synthesize the PC video signal and the TV video signal, and therefore, as described above, the TV digital RGB signals horizontal and vertically expanded by the TV scaling unit 130 are applied through the video signal synthesis unit 140 to the frame memory 150.

The frame memory 150 is for storing the digital RGB signals to be displayed on the display unit 200 and has at least the capacity of storing the digital RGB signals corresponding to the resolution of the display unit 200.

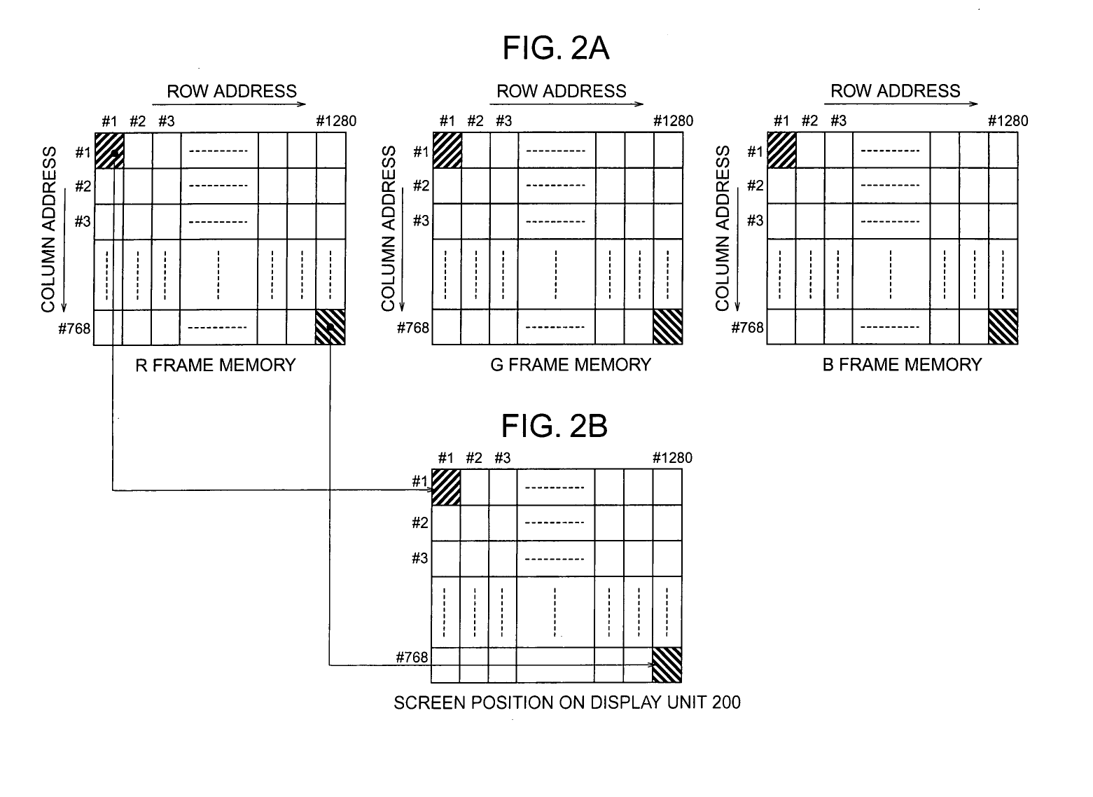

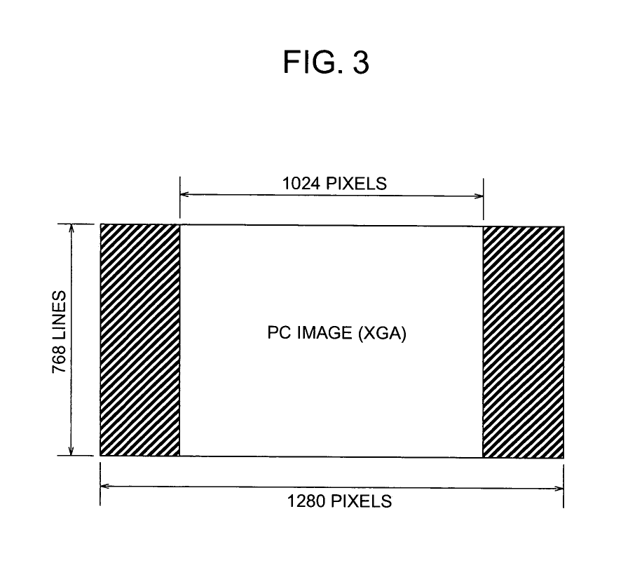

FIG. 2 is a diagram showing an illustration of the storage areas of the frame memory 150 for storing the digital RGB signals to be displayed on the display unit 200. In the case where the resolution of the display unit 200 is 1280 horizontal pixels and 768 vertical lines, for example, the storage area of the frame memory 150 for each of the RGB digital signals has a capacity of 1280 by 768 as shown in FIG. 2A, and the TV digital RGB signals horizontally and vertically expanded into coincidence with the resolution of the display unit 200 by the TV scaling unit 130 are each stored in the corresponding area of the frame memory 150 after one-to-one mapping.

An example of the mapping method is shown in FIG. 2B. The area (row address #1, column address #1) of each of the R, G and B frame memories is mapped to the pixel at the upper left corner of the display screen of the display unit 200 and the area (row address #768, column address #1280) of each of the R, G and B frame memories is mapped to the pixel at the lower right corner of the display screen of the display unit 200. The TV digital RGB signals (having 1280 horizontal effective pixels per line and 768 vertical effective lines per frame), which have been been horizontally and vertically expanded by the TV scaling unit 130 into coincidence with the resolution of the display unit 200 and stored at predetermined addresses of the frame memory 150, are sequentially read through the video signal synthesis unit 140 and supplied to and displayed on the display unit 200.

Through the series of the process described above, the TV video signal of the TV broadcast program selectively received by the tuner 20 is displayed over the whole screen of the display unit 200 with the resolution thereof, so that the user can view the TV broadcast program.

Next, an explanation is given about a case in which the display device according to this embodiment has an input terminal for the PC video signal output from the PC and the PC video signal is displayed over the whole screen of the display unit 200.

The PC input terminal 40 shown in FIG. 1 is supplied with the PC video signal (RGB signals) which is output from the PC and supplied to an A/D converter 160 in the video signal processing unit 100. This embodiment will be explained with reference to an example in which the resolution of the PC video signal (RGB signals) output from the PC is set to what is called XGA (1024 horizontal effective pixels per line and 768 vertical effective lines per frame).

The A/D converter 160 converts the input PC video signal in analog form to a digital signal at a predetermined sampling frequency. In the case where the PC video signal has the resolution XGA, the sampling frequency is set to 1024 horizontal effective pixels per line (per horizontal scanning line). On the other hand, the number of vertical effective lines is 768 per frame for XGA. Therefore, the A/D converter 160 outputs the digital PC video signal (PC digital RGB signals) having 1024 horizontal effective pixels per line and 768 vertical effective lines per frame. The digital PC video signal (PC digital RGB signals) to which the analog signal has been converted by the A/D converter 160 is output to a PC scaling unit 170.

The PC scaling unit 170, in order to display the input PC digital RGB signals in a predetermined image size on the display unit 200, operates in such a manner as to expand or compress the horizontal and vertical image sizes of the input PC digital RGB signals. In the case where the PC video signal has the resolution XGA, for example, the PC digital RGB signals input to the PC scaling unit 170 have an image size of 1024 horizontal effective pixels per line and 768 vertical effective lines per frame. In the case where the display unit 200 is configured of a liquid crystal panel of WXGA, i.e. the resolution of 1280 horizontal pixels and 768 vertical lines, however, an image size mismatch is caused between the PC digital RGB signals and the display unit 200.

For displaying the PC video signal from the PC input terminal 40 over the whole screen of the display unit 200, therefore, the PC scaling unit 170 operates in such a manner that the PC digital RGB signals having an image size of 1024 horizontal effective pixels per line and 485 vertical effective lines per frame are horizontally expanded to the PC digital RGB signals having an image size of 1280 horizontal effective pixels per line and 768 vertical effective lines per frame coincident with the resolution of 1280 horizontal pixels and 768 vertical lines of the display unit 200. This magnification is given as an instruction to the PC scaling unit 170 from from the system control unit 30 for controlling the whole display device according to the invention.

The PC digital RGB signals (with 1280 horizontal effective pixels per line and 768 vertical effective lines per frame) expanded to coincide with the resolution of the display unit 200 by the PC scaling unit 170 are supplied to the frame memory 150 through the video signal synthesis unit 140. In the case where the PC video signal input from the PC input terminal 40 is displayed over the whole screen of the display unit 200, there is no special need to synthesize the TV video signal and the PC video signal. The PC digital RGB signals (1280 horizontal effective pixels per line and 768 vertical effective lines per frame) that have been horizontally expanded to the resolution of the display unit 200 by the PC scaling unit 170 and stored at a predetermined address of the frame memory 150 are sequentially read through the video signal synthesis unit 140 and supplied to and displayed on the display unit 200.

Through the series of the process described above, the PC video signal input from the PC input terminal 40 is displayed over the whole screen of the display unit 200 with the resolution thereof, so that the user can use the display device according to this invention as a PC monitor.

In the embodiment described above, the PC video signal having the XGA resolution input from the PC input terminal 40 is horizontally expanded by the PC scaling unit 170 to match with the resolution of the display unit 200. As an alternative, the PC digital RGB signals output from the A/D converter 160 are stored in a predetermined area of the frame memory 150 without being horizontally expanded by the PC scaling unit 170 and the PC video signal having the XGA resolution is displayed at the central part of the display screen as illustrated in FIG. 3. In this way, the originally input PC video signal can be displayed without deteriorating the resolution thereof. In this process, the PC video signal can be displayed at other than the central part of the display screen depending on the area of the frame memory 15 in which it is written.

On the other hand, assume that the PC video signal input from the PC input terminal 40 has what is called the VGA resolution (640 horizontal effective pixels per line and 480 vertical effective lines per frame). Based on the instruction from the system control unit 30, the PC scaling unit 170 horizontally and vertically expands the PC video signal having the VGA resolution to 1280 horizontal effective pixels per line and 768 vertical effective lines per frame. In this way, the PC video signal can be displayed over the whole screen of the display unit 200. As described above, in displaying the PC video signal over the whole screen of the display device according to this invention, the resolution of the PC video signal input from the PC input terminal 40 is not specifically limited.

Further, unlike in the embodiment described above in which the input PC video signal is converted into a digital signal by the A/D converter 160, the PC video signal, if in digital form, is input and output to the PC scaling unit 170 with the designated resolution information.

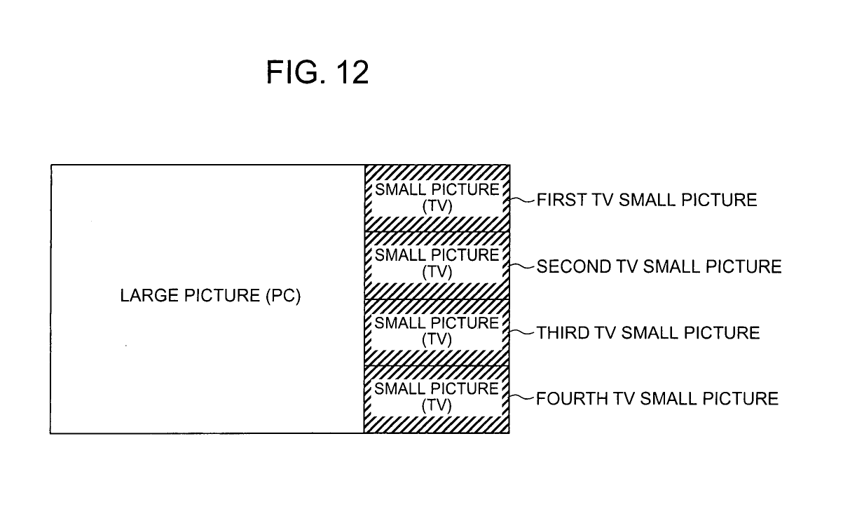

Next, an explanation is given in detail about a case in which, as shown in FIG. 12, the PC video signal constituting a large picture and the TV video signal constituting small pictures are displayed in tiles without mutual superposition. As in the case described above, assume that the PC video signal input from the PC input terminal 40 has what is called the XGA resolution (1024 horizontal effective pixels per line and 768 vertical effective lines per frame) and the TV video signal is the NTSC signal. Also assume that the display unit 200 is a liquid crystal panel having the resolution of 1024 horizontal effective pixels per line and 768 vertical effective lines per frame.

The PC video signal having the XGA resolution input from the PC input terminal 40, as in the aforementioned case, is converted from the analog form into a digital signal by the A/D converter 160 based on the instruction from the system control unit 30, so that the PC digital RGB signals having 1024 horizontal effective pixels per line and 768 vertical effective lines per frame are applied to the PC scaling unit 170. In the PC scaling unit 170, the input PC digital RGB signals are not specifically expanded or compressed, but the PC digital RGB signals having the above-mentioned resolution and the original image size are supplied to the video signal synthesis unit 140. The video signal synthesis unit 140 operates, in response to the instruction from the system control unit 30, in such a manner that the PC digital RGB signals supplied to the video signal synthesis unit 140 are stored in predetermined areas of the frame memory 150.

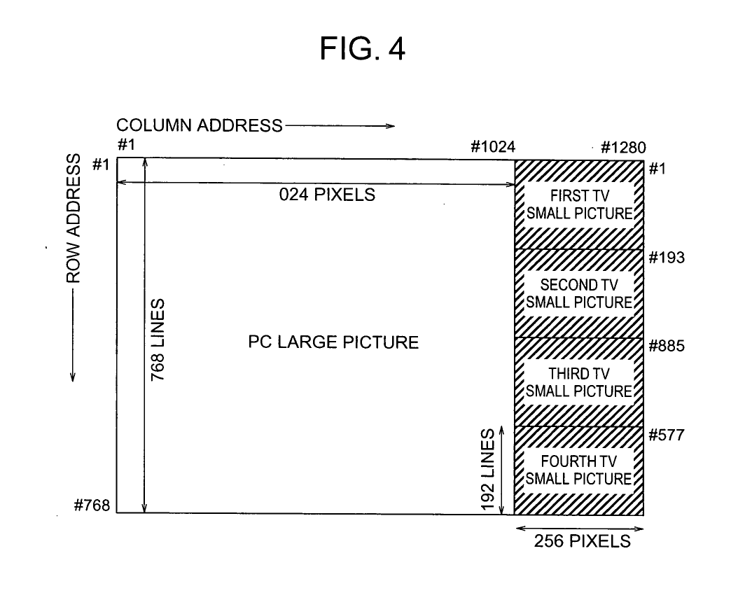

In the process, as shown in FIG. 2, the frame memory 150 is such that the mapping is made so that the area (row address #1, column address #1) of each frame memory of R, G and B is mapped to the pixel at the upper left corner of the display screen of the display unit 200 and the area (row address #768, column address #1280) of each frame memory of R, G and B to the pixel at the lower right corner of the display screen of the display unit 200. The PC digital RGB signals having 1024 horizontal effective pixels per line and 768 vertical effective lines per frame supplied through the video signal synthesis unit 140, therefore, are mapped to the areas of (row address #1, column address #1) to (row address #768, column address #1024) as shown in FIG. 12 to display the PC video signal on the extreme left side of the display screen of the display unit 200 as shown in FIG. 4 and stored as a large picture shown in FIG. 12. FIG. 4 is a diagram showing an example of the storage areas of the frame memory 150 in the case where the PC video signal and the TV video signal are arranged and displayed as a patent screen and small pictures, respectively, on the same picture plane without mutual superposition, as intended by the invention.

On the other hand, the TV broadcast radio wave supplied from the antenna input terminal 10 is input to the tuner 20. Once a tuning instruction is input to the system control unit 30 through the remote control signal receiving unit 301 by the user operation of the remote controller 300, as described above, the system control unit 30 instructs the tuner 20 to receive a predetermined TV broadcast program (channel) designated by the tuning operation. Based on the tuning instruction from the system control unit 30, the tuner 20 selects and receives a predetermined TV broadcast program (channel), and outputs the TV video signal (NTSC signal) of the selected TV broadcast program. The TV video signal (NTSC signal) received and output by the tuner 20 is subjected to the signal conversion process similar to the aforementioned case by the AD converter 110 and the RGB converter 120 in the video signal processing unit 100, with the result that the TV digital RGB signals having 768 horizontal effective pixels per line and 485 vertical effective lines per frame are supplied to the TV scaling unit 130.

The TV digital RGB signals having 768 horizontal effective pixels per line and 485 vertical effective lines per frame supplied to the TV scaling unit 130, as shown in FIG. 12, are horizontally and vertically compressed to the image size of 256 horizontal effective pixels per line and 192 vertical effective lines per frame by the TV scaling unit 130 to be displayed as small pictures of a predetermined size. The TV digital RGB signals having 256 horizontal effective pixels per line and 192 vertical effective lines per frame horizontally and vertically compressed by the TV scaling unit 130 are supplied to the video signal synthesis unit 140.

The video signal synthesis unit 140, based on the instruction from the system control unit 30, operates in such a manner that the TV digital RGB signals supplied to the video signal synthesis unit 140 are stored in predetermined areas of the frame memory 150. Specifically, in order that the TV digital RGB signals having 256 horizontal effective pixels per line and 192 vertical effective lines per frame may be displayed on the display unit 200 in the first display area of the TV video signal, as shown in FIG. 12, the TV digital RGB signals are mapped to the areas of (row address #1, column address #1025) to (row address #192, column address #1280), respectively, and as shown in FIG. 4, stored as a first TV small picture in FIG. 12.

In similar fashion, the TV digital RGB signals supplied to the video signal synthesis unit 140 are stored, as second, third and fourth TV small pictures, respectively, in the areas of (row address #193, column address #1025) to (row address #384, column address #1025) as shown in FIG. 4 in order to display the TV digital RGB signals on the display unit 200 in the second display area of the TV video signal as shown in FIG. 12; in the areas of (row address #385, column address #1025) to (row address #576, column address #1280 as shown in FIG. 4 in order to display the TV digital RGB signals on the display unit 200 in the third display area of the TV video signal as shown in FIG. 12; and in the areas of (row address #577, column address #1025) to (row address #768, column address #1280) as shown in FIG. 4 in order to display the TV digital RGB signals on the display unit 200 in the fourth display area of the TV video signal as shown in FIG. 12.

As described above, the PC digital RGB signals (large picture) and the TV digital RGB signals (small pictures) stored in predetermined areas of the frame memory 150 are sequentially read through the video signal synthesis unit 140 and supplied to and displayed on the display unit 200. In this way, the PC video signal and the TV video signal are mapped to, stored in and read from, with a predetermined image size, predetermined areas of the frame memory 150. Thus, as shown in FIG. 2, the PC large picture and a plurality of the TV small pictures can be arranged and displayed without any superposed relation with each other in the display unit 200. Further, since the image size of the TV small picture is 256 horizontal effective pixels per line and 192 vertical effective lines per frame while the aspect ratio of the TV video signal is held at 4:3, the TV video signal can be displayed horizontally and vertically without any image distortion on the small pictures.

In the foregoing description, the PC video signal supplied from the PC input terminal is assumed to have the resolution of XGA. In the display device according to this invention, however, the resolution is not so limited. In the case where the resolution of the PC video signal is VGA (640 horizontal effective pixels per line, and 480 vertical effective lines per frame), for example, the image size is horizontally and vertically expanded to 1024 horizontal effective pixels per line and 768 vertical effective lines per frame by the PC scaling unit 170. Then, as in the case where the resolution of the PC video signal is XGA, the PC large picture and a plurality of TV small pictures can be arranged and displayed without superposition in the display unit 200 as shown in FIG. 2. Specifically, the PC scaling unit 170 has the function of changing the image size in accordance with the resolution of the PC video signal, and therefore the resolution of the PC video signal is not specifically limited in the display device according to the invention.

As apparent from the foregoing description, the PC video signal supplied from the PC input terminal is not compressed by the PC scaling unit 170, and therefore displayed on the display unit 200 as a PC large picture without deteriorating the resolution thereof. At the same time, each TV small picture is displayed by holding the TV video signal at the aspect ratio of 4:3. Thus, the PC video signal is displayed on the display unit 200 without image distortion in horizontal and vertical directions.

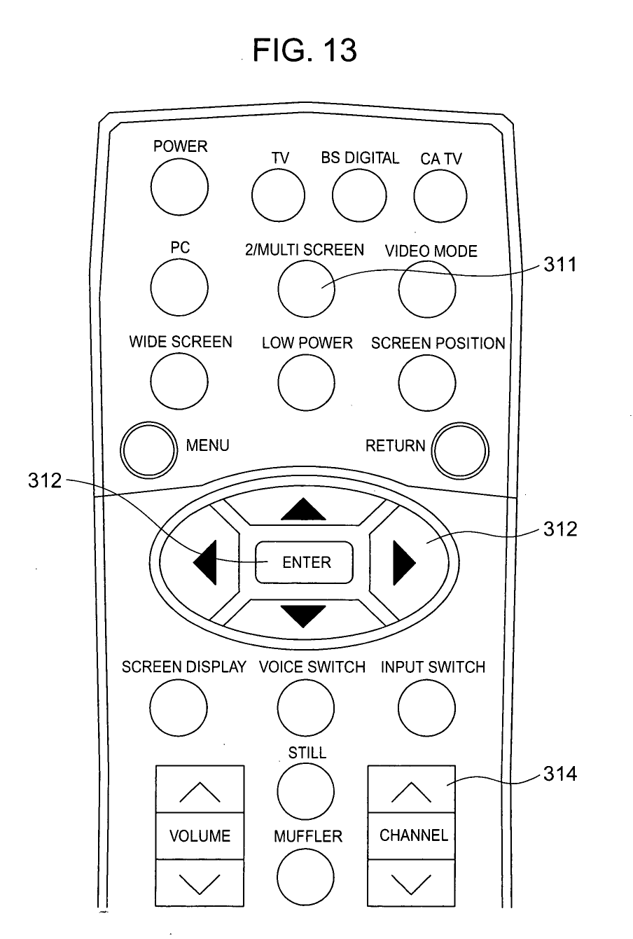

Next, the remote controller 300 is explained in detail with reference to FIG. 3. The remote controller 300 has a plurality of remote control buttons which are depressed to select the functions of the display device. The operation of typical ones of the buttons is explained. The 2/MULTI SCREEN button 311 is for selecting the multi-tile display function of the PC large picture and the TV small pictures described above and the picture-in-picture function described with reference to the prior art. This button 311 works effectively in PC mode. The PC mode is attained by depressing the PC button shown in FIG. 13. Of the four cursor buttons 312, up, down, left and right, the left and right buttons are used to select the display mode of the TV small pictures described later, and the upper and lower buttons are for changing the select window of the TV small pictures described later. An ENTER button 312 is arranged at the center of the cursor buttons 312 and depressed for shifting from PC mode to TV mode in which the TV small picture select window is displayed over the whole screen. By depressing the upper or lower one of CHANNEL buttons 314, the TV channel displayed on the select window of the TV small picture is changed.

As the result of depression of these buttons, the remote controller 300 outputs the display device operation information, which is received by a remote control signal receiving unit 301 to transmit the operation information to the system control unit 30. The system control unit 30, based on the operation information from the remote controller 300, conducts the above-mentioned operation of A/D conversion, scaling and synthesis of the PC video signal and the TV video signal described above.

In the display device according to the invention described above, the PC video signal is displayed as a large picture and the TV video signal as a plurality of small pictures on the same screen at the same time in a manner not to be superposed one on another as shown in FIG. 12. Further, a method of renewing the display of the TV video signal as a plurality of small pictures is explained specifically.

First, an explanation is given about the first display renewal mode of the display device according to the invention.

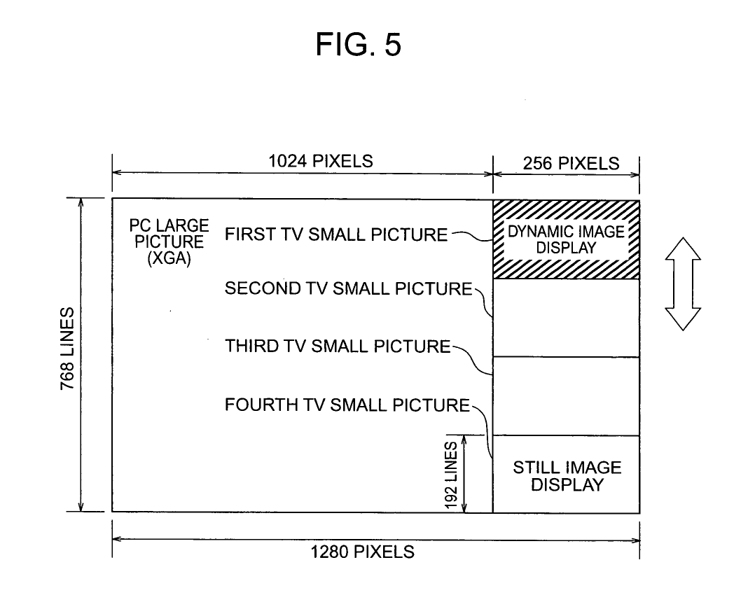

In the first display renewal mode of the display device according to this invention, as shown in FIG. 5, the TV video signal of the TV broadcast program of the desired one of the first to fourth TV small pictures designated by the remote control operation of the user is renewed as a dynamic image. This first display renewal mode is implemented by the remote control operation described below.

(Step 1)

The user, operating the remote controller 300, selects one of the first to fourth TV small pictures on which the TV broadcast program desired by the user is to be displayed as a dynamic image of the TV video signal.

(Step 2)

The user, operating the remote controller 300, tunes to the desired TV broadcast program (channel) to be displayed on the TV small picture selected in Step 1.

The display device according to the invention shown in FIG. 1 is operated as described below following the steps mentioned above. The information on the TV small picture and the TV broadcast program (channel) to be displayed on the particular small picture selected in Steps 1 and 2 above are transmitted to the system control unit 30 through a remote control signal receiving unit 301. Based on this information, the system control unit 30 designates the TV broadcast program (channel) to be selected and received by the tuner 20. In response to this designation, the tuner 20 selectively receives the TV broadcast program (channel) designated by the remote control operation of the user. Subsequently, the TV video signal (say, NTSC signal) of the TV broadcast program selected in the same manner as described above is converted to a digital signal by the A/D converter 110, processed by the RGB converter 120 and horizontally and vertically compressed in image size by the TV scaling unit 130. The signal thus processed is supplied to the video signal synthesis unit 140. The system control unit 30, based on the information on the TV small picture designated by the remote control operation in Step 1 above, instructs the video signal synthesis unit 140 to store the supplied TV video signal in a designated TV small picture storage area of the frame memory 150. The video signal synthesis unit 140, based on the instruction from the system control unit 30, stores the supplied TV video signal in the designated TV small picture storage area of the frame memory 150 while at the same time reading the TV video signal and displaying it on the display unit 200.

In this way, the TV video signal of the TV broadcast program desired by the user is displayed as a dynamic image on the TV small pictures designated by the remote control operation of the user.

The user, by repeating the remote control operation of Steps 1 and 2, can display the TV video signal as a dynamic image of the TV broadcast program designated by the user on the first to fourth TV small pictures. For example, the user can manipulate the remote controller first to display a dynamic image of the TV video signal of the TV broadcast program designated by the user on the first TV small picture, and then to display a dynamic image of a different TV broadcast program on the second TV small picture. In this case, the TV video signal of the TV broadcast program designated by the user is displayed as a dynamic image on the second TV small picture as described above. On the first TV small picture, however, the TV video signal stored in the first TV small picture storage area of the frame memory immediately before the remote control operation of the user to display the dynamic image of the different TV broadcast program on the second TV small picture is displayed as a still image.

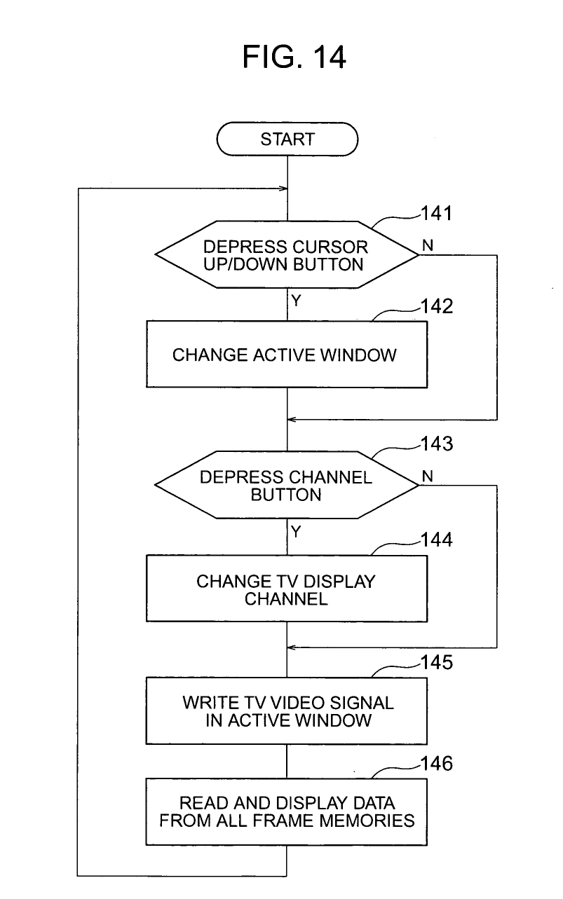

This process is shown as a flowchart in FIG. 14. Upon depression of the cursor up/down buttons of the remote controller 300 (step 141), an active window for displaying a dynamic image of the TV video signal is changed in accordance with the up/down instruction of the cursor up/down buttons (step 142). Next, the channel button of the remote controller 300 is depressed (step 143) to change the channel number of the TV broadcast to display a dynamic image on the active window (step 144). After that, the digital TV video signal processed by the scaling unit is written in the area of the active window on the frame memory (step 145). In the case where neither the cursor up/down buttons or the channel button is depressed, on the other hand, the TV video signal of the previously set channel number is written in the previously set active window. The data in all the frame memories including the PC video signal and a plurality of the TV small pictures windows are read and output to the display unit (step 146). By repeating this process, the dynamic image of the designated channel is displayed on the active window (active small picture), while the last still image of the channel displayed in the previously-set active window is displayed in an inactive window (another small picture). In this way, a desired small pictures can be selected and a dynamic image can be displayed in the selected small pictures by operating the cursor up/down buttons.

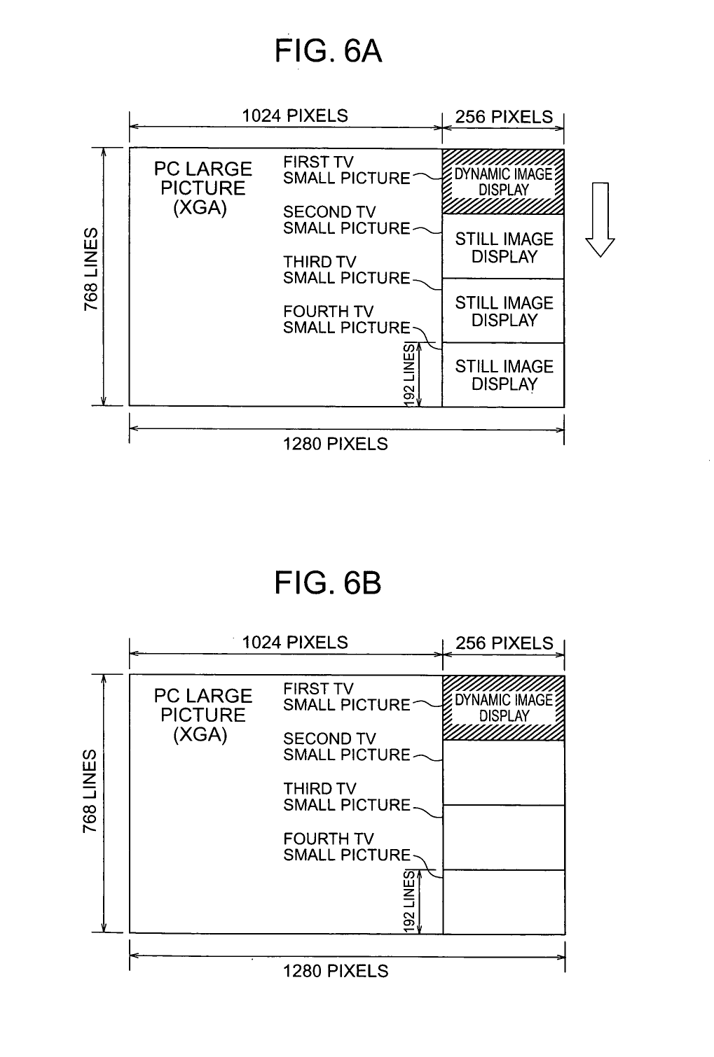

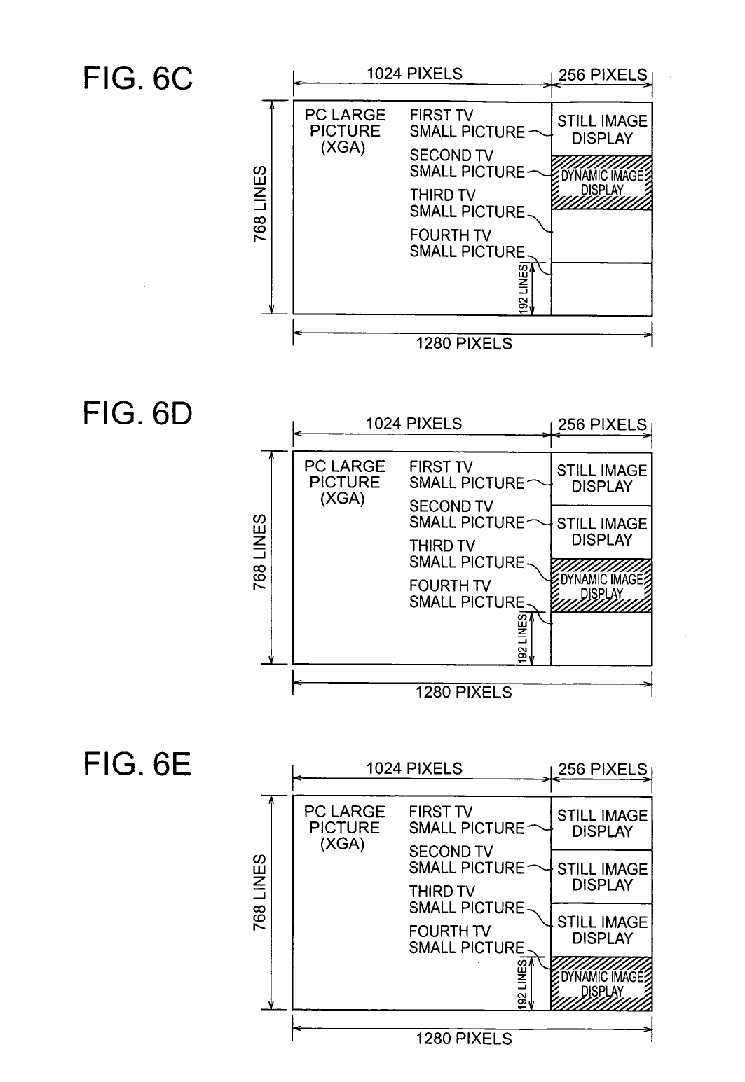

Next, the second display renewal mode of the display device according to the invention is explained. In the second display renewal (update) mode of the display device according to the invention, as shown in the diagram of FIG. 6A, the TV small picture in which the TV video signal of the designated TV broadcast program is displayed as a dynamic image is sequentially shifted at predetermined time intervals (say, five seconds) from the first to fourth TV small pictures thereby to automatically renew the display. This second display renewal mode is implemented by the sequences described below.

(Sequence 1)

In the block diagram of FIG. 1 showing the display device, the TV broadcast program (channel) to be displayed on the first TV small picture is selectively received through the tuner 20 in response to the instruction from the system control unit 30. The TV video signal (NTSC signal, for example) of the selected TV broadcast program is converted to a digital signal by the A/D converter 110, processed by the RGB converter 120 and horizontally and vertically compressed in image size by the TV scaling unit 130. The resultant signal is stored in the first TV small picture storage area of the frame memory 150 through the video signal synthesis unit 140, while at the same time being read and displayed on the display unit 200. While continuing this process for a predetermined length of time (say, five seconds), the PC video signal is displayed as a large picture on the display unit 200. At the same time, the TV video signal of the TV broadcast program (channel) selectively received to be displayed on the first TV small picture is continuously displayed as a dynamic image on the first TV small picture (FIG. 6B).

(Sequence 2)

In the block diagram of FIG. 1 showing the display device, the TV broadcast program (channel) to be displayed on the second TV small picture is selectively received by the tuner 20 in response to the instruction from the system control unit 30, and the TV video signal (NTSC signal, for example) of the selected TV broadcast program is converted to a digital signal by the A/D converter 110, processed by the RGB converter 120 and horizontally and vertically compressed in image size by the TV scaling unit 130. The resultant signal is stored in the second TV small picture storage area of the frame memory 150 through the video signal synthesis unit 140, while at the same time being read and displayed on the display unit 200. This process is continued for a predetermined time length (say, five seconds), during which time the PC video signal is displayed as a large picture on the display unit 200 on the one hand, and the TV video signal of the TV broadcast program (channel) selectively received to be displayed on the second TV small picture is continuously displayed as a dynamic image on the second TV small picture on the other hand. In the process, the last TV video signal stored in the first TV small picture storage area of the frame memory 150 in shifting from Sequence 1 to 2 is read from the frame memory 150 and displayed on the first TV small picture as a still image (FIG. 6C).

(Sequence 3)

In the block diagram of FIG. 1 showing the display device, the TV broadcast program (channel) to be displayed on the third TV small picture is selectively received by the tuner 20 based on the instruction from the system control unit 30. The TV video signal (NTSC signal, for example) of the TV broadcast program thus selected is converted to a digital signal by the A/D converter 110, processed by the RGB converter 120 and horizontally and vertically compressed in image size by the TV scaling unit 130. The resultant signal is stored in the third TV small picture storage area of the frame memory 150 through the video signal synthesis unit 140, while at the same time being read and displayed on the display unit 200. This process is continued for a predetermined time length (say, five seconds), during which time the PC video signal is displayed as a large picture on the display unit 200 on the one hand and the TV video signal of the TV broadcast program (channel) selectively received to be displayed on the third TV small picture is continuously displayed as a dynamic image on the third TV small picture on the other hand. In the process, the last TV video signal stored in the first TV small picture storage area of the frame memory 150 in shifting from Sequence 1 to Sequence 2 is read from the frame memory 150 and displayed on the first TV small picture as a still image. In similar fashion, the last TV video signal stored in the second TV small picture storage area of the frame memory 150 in shifting from Sequence 2 to 3 is read from the frame memory 150 and displayed as a still image on the second TV small picture (FIG. 6D).

(Sequence 4)

In the block diagram of FIG. 1 showing the display device, the TV broadcast program (channel) to be displayed on the fourth TV small picture is selectively received by the tuner 20 based on the instruction from the system control unit 30. The TV video signal (NTSC signal, for example) of the TV broadcast program thus selected is converted to a digital signal by the A/D converter 110, processed by the RGB converter 120 and horizontally and vertically compressed in image size by the TV scaling unit 130. The resultant signal is stored in the fourth TV small picture storage area of the frame memory 150 through the video signal synthesis unit 140, while at the same time being read and displayed on the display unit 200. This process is continued for a predetermined time length (say, five seconds), during which time the PC video signal is displayed as a large picture on the display unit 200 and the TV video signal of the TV broadcast program (channel) selectively received to be displayed on the fourth TV small picture is continuously displayed as a dynamic image on the fourth TV small picture. In the process, the last TV video signal stored in the first TV small picture storage area of the frame memory 150 in shifting from Sequence 1 to Sequence 2 is read from the frame memory 150 and displayed on the first TV small picture as a still image; the last TV video signal stored in the second TV small picture storage area of the frame memory 150 in shifting from Sequence 2 to 3 is read from the frame memory 150 and displayed as a still image on the second TV small picture; and the last TV video signal stored in the third TV small picture storage area of the frame memory 150 in shifting from Sequence 3 to 4 is read from the frame memory 150 and displayed as a still image on the third TV small picture (FIG. 6E).

Sequences 1 to 4 are repeated sequentially to display the PC video signal as a large picture, while at the same time displaying the TV video signal of different TV broadcast programs as a renewed dynamic image at predetermined time intervals (say, five seconds) sequentially on the first to fourth TV small pictures. As apparent from the foregoing description, a dynamic image is displayed in only one of the first to fourth TV small pictures. The TV small pictures on which a dynamic image is displayed is shifted sequentially from the first to fourth TV small pictures at predetermined time intervals (say, five seconds) for each sequence, while the last TV video signal stored in the frame memory 150 at the time of shifting each sequence is displayed as a still image on each of the other TV small pictures in which no dynamic image is displayed.

The TV small pictures on which a dynamic image is desired to be displayed and the TV broadcast program (channel) displayed on the particular small pictures can be designated by the remote control operation of the user in Sequences 1 and 2 described above with reference to the first display renewal mode.

In this way, a plurality of TV broadcast programs are sequentially displayed as a dynamic image on the small pictures while displaying the PC screen, and therefore different programs can be viewed concurrently.

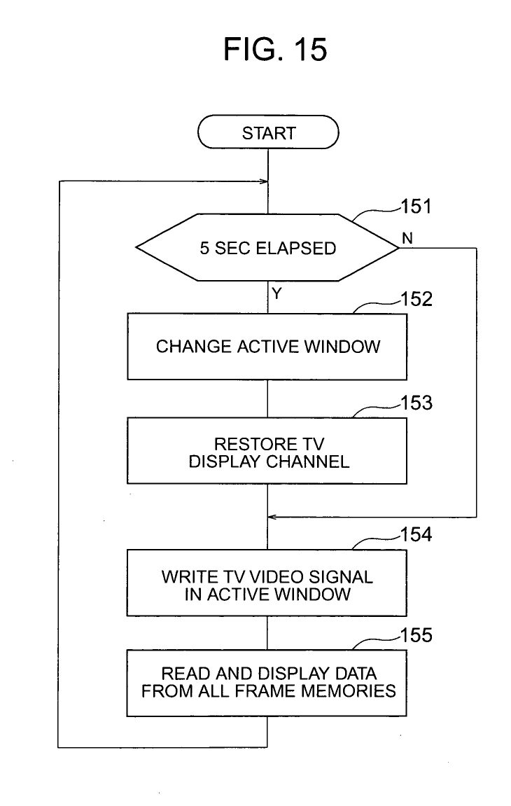

The process described above is illustrated in the flowchart of FIG. 15. The lapse of five-second periods is monitored (step 151). At intervals of five seconds, the active window on which the TV video signal is displayed as a dynamic image is changed (step 152), and the channel number of the TV broadcast program displayed as a dynamic image is restored to a predefined active window (step 153). After that, the digital TV video signal that has been processed by the scaling unit is written in the area of the active window on the frame memory (step 154). Until the lapse of the next five-second period is detected, the TV video signal designated by the channel number is written in the particular active window. Thus, the PC video signal and the data of all the frame memories including a plurality of TV small picture windows are read and output to the display unit (step 155).

By repeating this process, for one five-second period, the dynamic image of the designated channel is displayed in the active window (active small picture) while the last still image of the channel that has been displayed when previously active is displayed in each of the inactive windows (other small pictures). For the next five-second period, the next TV small picture becomes active. In other words, a TV screen can be automatically displayed on a plurality of small pictures on rotation at intervals of five seconds.

Further, the third display renewal mode of the display device according to this invention is explained.

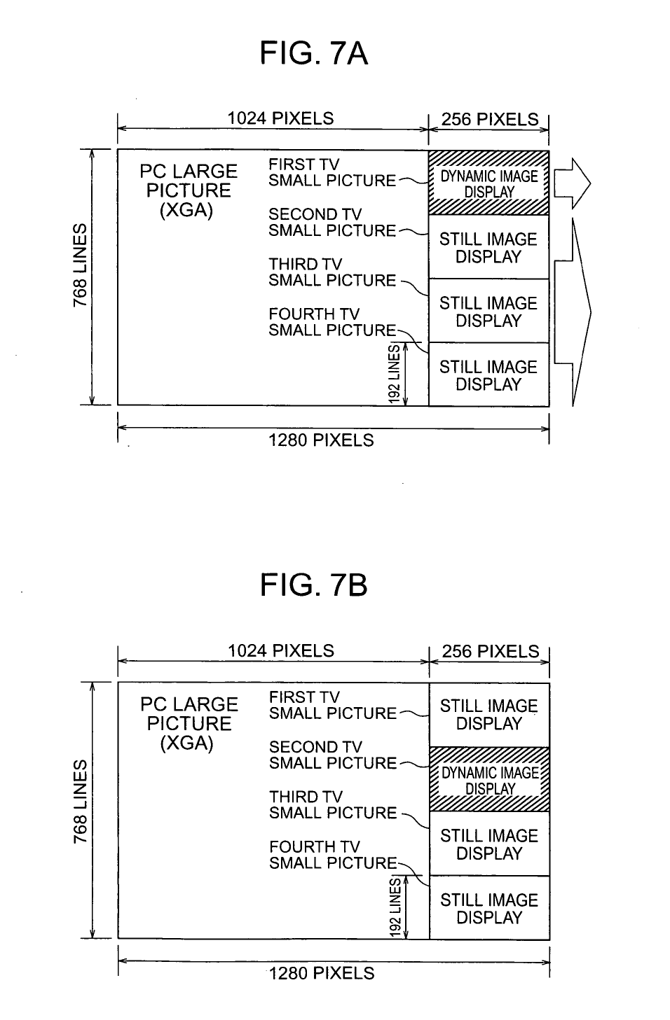

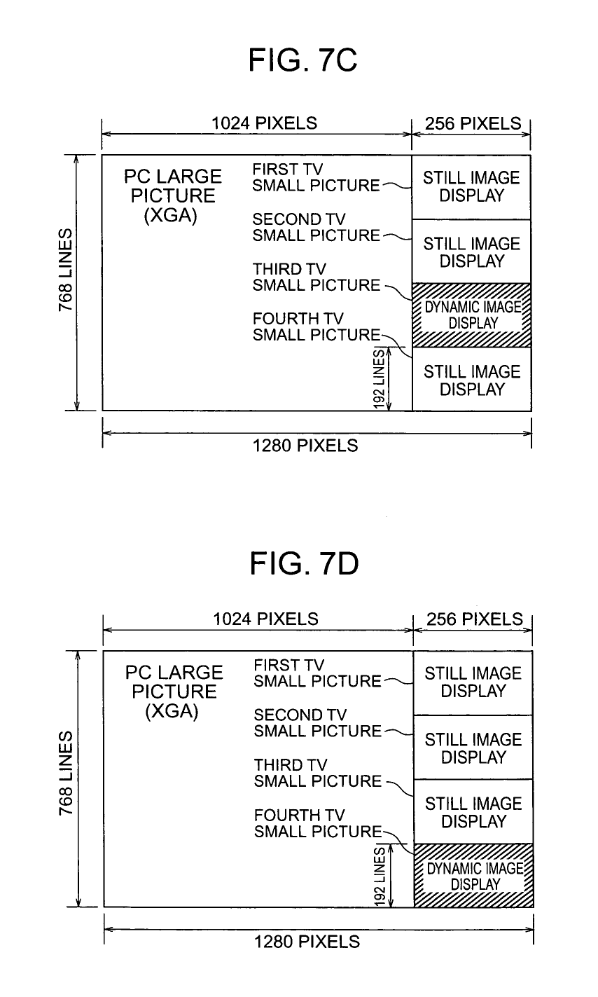

In the third display renewal mode of the display device according to the invention, as shown in FIG. 7A, one (first TV small picture, for example) of the first to fourth TV small pictures is set as a dynamic image display small picture while the other three TV small pictures (second, third and fourth TV small pictures, for example) are set as still image display small pictures. These pictures are automatically renewed and displayed collectively at predetermined time intervals (10 seconds, for example). The third display renewal mode is implemented by the following sequences:

(Sequence 1)

In the block diagram of FIG. 1 showing the display device, the TV broadcast program (channel) to be displayed on the first TV small picture is selectively received through the tuner 20 in response to the instruction from the system control unit 30. The TV video signal (NTSC signal, for example) of the selected TV broadcast program is converted to a digital signal by the A/D converter 110, processed by the RGB converter 120 and horizontally and vertically compressed in image size by the TV scaling unit 130. The resultant signal is stored in the first TV small picture storage area of the frame memory 150 through the video signal synthesis unit 140, while at the same time being read and displayed on the display unit 200. The PC video signal is displayed as a large picture on the display unit 200. At the same time, the TV video signal of the TV broadcast program (channel) selectively received to be displayed on the first TV small picture is continuously displayed as a dynamic image on the first TV small picture.

(Sequence 2)

The TV video signal of the TV broadcast program (channel) selectively received to be displayed on the first TV small picture is continuously displayed on the first TV small picture for a predetermined period of time (say, ten seconds) in Sequence 1. After that, based on the instruction from the system control unit 30, the TV broadcast program (channel) to be displayed on the second TV small picture is selectively received through the tuner 20, and the TV video signal (NTSC signal, for example) of the TV broadcast program selected is converted to a digital signal in the A/D converter 110, processed in the RGB converter 120 and horizontally and vertically compressed in image size in the TV scaling unit 130. The resulting signal is stored in the second TV small picture storage area of the frame memory 150 through the video signal synthesis unit 140. After that, the TV broadcast programs (channels) to be displayed on the third and fourth TV small pictures are selectively received similarly based on the instruction from the system control unit 30, and sequentially stored in the third and fourth TV small picture storage areas, respectively, of the frame memory 150.

As a result, the TV video signals of different TV broadcast programs are stored as still images in the second, third and fourth TV small picture storage areas of the frame memory 150. These still images, immediately after being thus stored, are read and displayed on the display unit 200. On the display unit 200, the PC video signal is displayed as a large picture on the one hand, and the TV video signal of the TV broadcast program (channel) selectively received to be displayed on the first TV small picture is continuously displayed on the first TV small pictures as a dynamic image like in Sequence 1 on the other hand. At the same time, the TV video signals of the TV broadcast programs selectively received in this sequence are displayed as still images on the second, third and fourth TV small pictures, respectively.

Sequences 1 and 2 are repeated one after another thereby to display the PC video image as a large picture, while at the same time continuously displaying on the first TV small picture the TV video signal of the TV broadcast program (channel) selectively received to be displayed as a dynamic image on the first TV small picture. Also, on the second to fourth TV small pictures, the TV video signals of different TV broadcast programs (channels) selectively received are renewed and displayed, respectively, at predetermined time intervals (say, ten seconds) as still images.

The TV small picture on which a dynamic image is desired to be displayed and the TV broadcast program (channel) to be displayed on the particular small picture can be designated by the remote control operation of the user in Steps 1 and 2 explained above with reference to the first display renewal mode. As shown in FIGS. 7B to 7D, the TV small pictures on which a dynamic image can be displayed can be changed by the remote control operation of the user.

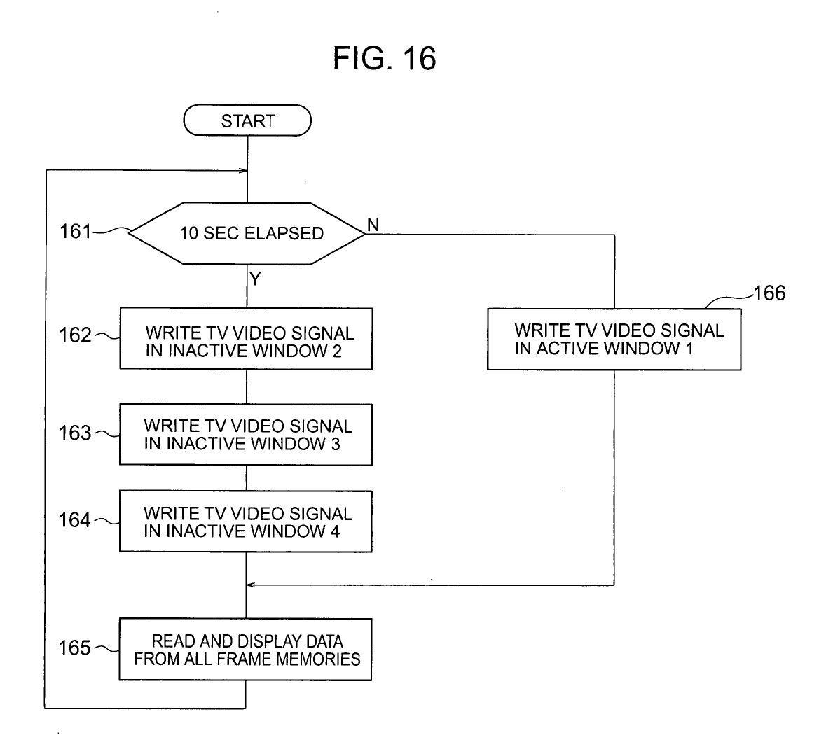

The aforementioned process is shown as a flowchart in FIG. 16. The lapse of a ten-second period is monitored (step 161). In every ten-second period, a still image processed by the scaling unit for the channel displayed in each of the windows other than active window in which the TV video signal is displayed as a dynamic image is written in the particular inactive window (steps 162, 163, 164). During each ten-second period, the video signal processed by the scaling unit for the channel to be displayed in the active window is written in the particular active window (step 166). The data in all the frame memories including a plurality of the TV small picture windows and the PC video signal are read and output to the display unit (step 165).

The active window is changed by the cursor up/down buttons of the remote controller, and the channel displayed in each window is changed by depressing the channel button.

By repeating this process, a dynamic image is displayed on the small picture selected as an active window, while the other small pictures are automatically renewed in display at every ten-second period.

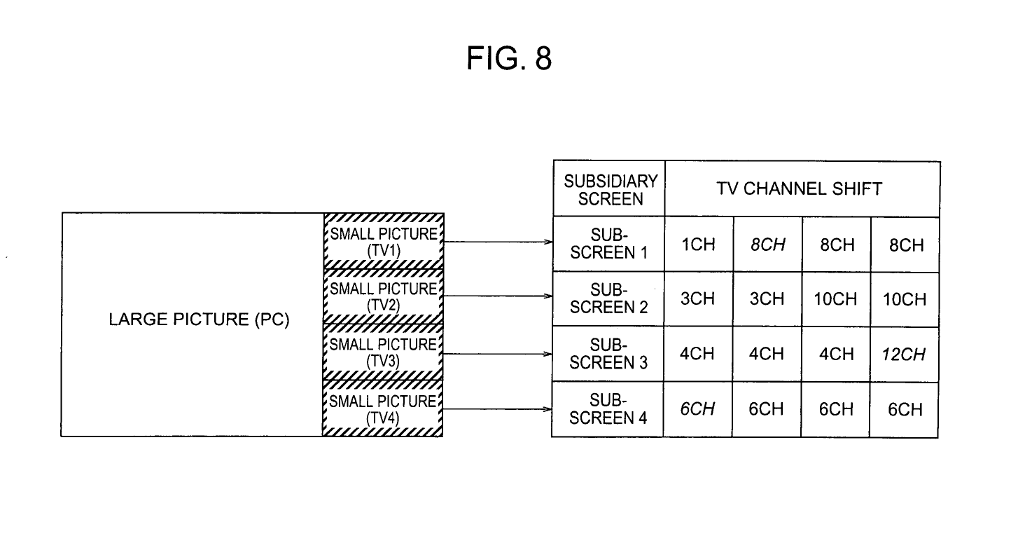

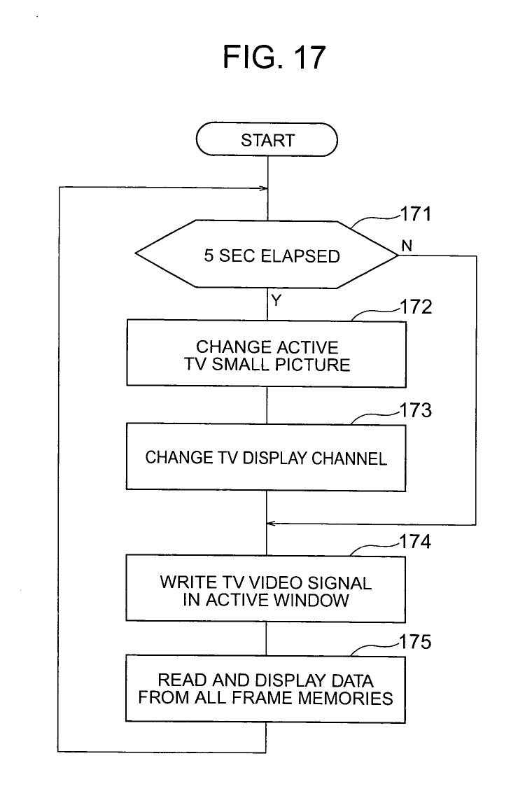

Next, with reference to FIGS. 8 and 17, explanation is given of an example in which the active window is shifted automatically at regular time intervals to display the next channel so that all the channels receivable are sequentially displayed. FIG. 8 is a schematic diagram showing the shift of the TV channel displayed on each small picture. Among the channels shifted, those written in italics indicate the channels (active channels) in which a dynamic image is displayed. The small picture in which a dynamic image is displayed is shifted at predetermined time intervals (say, five seconds) thereby to display all the receivable channels sequentially. This circulatory display operation is conducted by changing the channel for each small picture.

FIG. 17 is a flowchart. The lapse of each five-second period is monitored (step 171). At each five-second interval, the active window in which the TV video signal is displayed as a dynamic image is changed (step 172), and so is the TV broadcast channel number in which a dynamic image is displayed in the active window (step 173). In the process, the channel number is changed and renewed to go around all the channels. After that, the digital TV video signal that has been processed by the scaling unit is written in the active window area on the frame memory (step 174). Until the lapse of the next five-second period is detected, the TV video signal designated by the channel number is written in the active window. The data of all the frame memories including a plurality of the small picture windows and the PC video signal are read and output to the display unit (step 175).

By repeating this process, during each five-second period, the dynamic image of the designated channel is displayed in the active window (active small picture), and the last still image of the channel displayed in each previously-set active and currently inactive small picture is displayed in each inactive window (another small picture). The next TV small picture becomes active for the next five-second period. In other words, all the TV pictures are automatically displayed in circulatory fashion at five-second intervals in a plurality of small pictures.

The system control unit 30 is operated and the video signal synthesis unit 140 and the frame memory 150 shown in FIG. 1 are controlled in the same manner as in other embodiments.

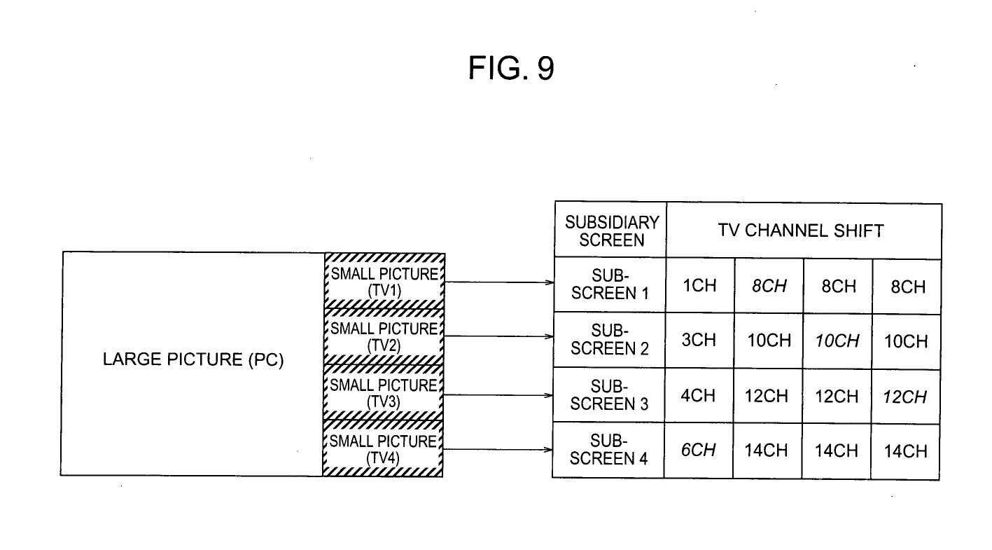

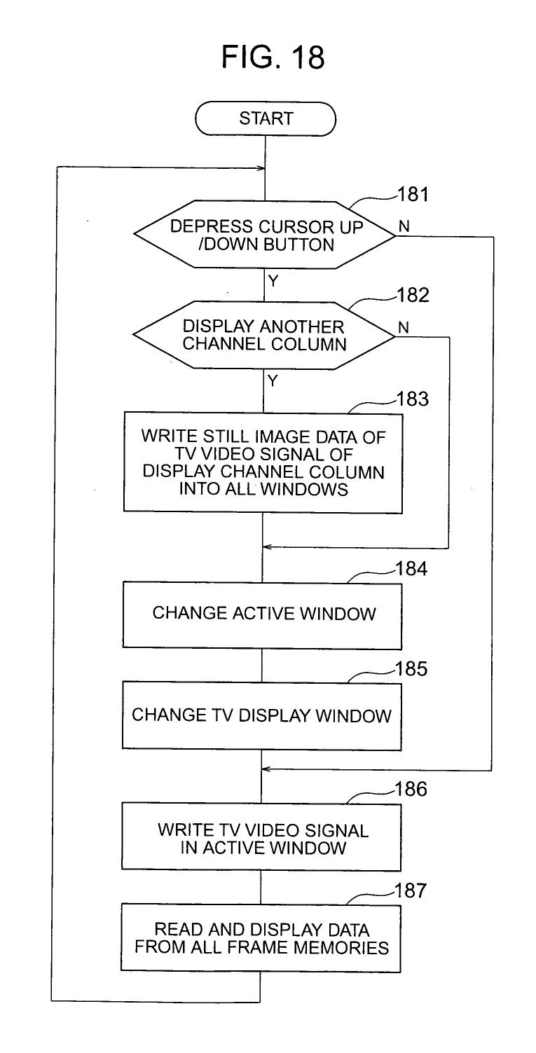

With reference to FIGS. 9 and 18, explanation is given of another case in which the active window is shifted to display the next channel in accordance with the depression of the cursor up/down buttons so that all the receivable channels are sequentially displayed. FIG. 9 is a schematic diagram showing the shift of the TV channel displayed on each small pictures. In shifting the TV channel, the (active) channel in which a dynamic image is displayed is written in italics. Upon each depression of the cursor up/down buttons, the small picture in which a dynamic image is displayed is shifted thereby to sequentially display all the receivable channels. The circulatory display is accomplished by changing as many channel columns as small pictures concurrently and thus switching the active screen.

FIG. 18 is a flowchart. Monitoring the depression of the cursor up/down buttons, and when one of the buttons is depressed (step 181), it is determined whether the channel column displayed in the small pictures is to be shifted to another channel column (step 182). In the case where the current active window is the small picture 4 (6 ch), for example, the next channel column (8 ch, 10 ch, 12 ch, 14 ch) is displayed upon depression of the cursor down button, while the small picture 4 (4 ch) is changed to an active window upon depression of the upper cursor button. In shifting to the next channel column in this way, the still image data of the TV video signal of the next display channel column is written temporarily in the frame memory for all the windows (step 183). The active window in which the TV video signal is displayed as a dynamic image is changed (step 184), and so is the TV display channel in which a dynamic image is displayed (step 185). After that, the digital TV video signal that has been processed by the scaling unit is written in the active window area on the frame memory (step 186). Then, the data of all the frame memories including a plurality of the TV small pictures windows and the PC video signal are read and output to the display unit (step 187).

By repeating this process, the small picture in which a dynamic image is displayed is shifted upon each depression of the cursor up/down buttons thereby to sequentially display all the receivable channels. In the circulatory display, as many channel columns as the small pictures are changed at the same time and the active picture screens can be switched.

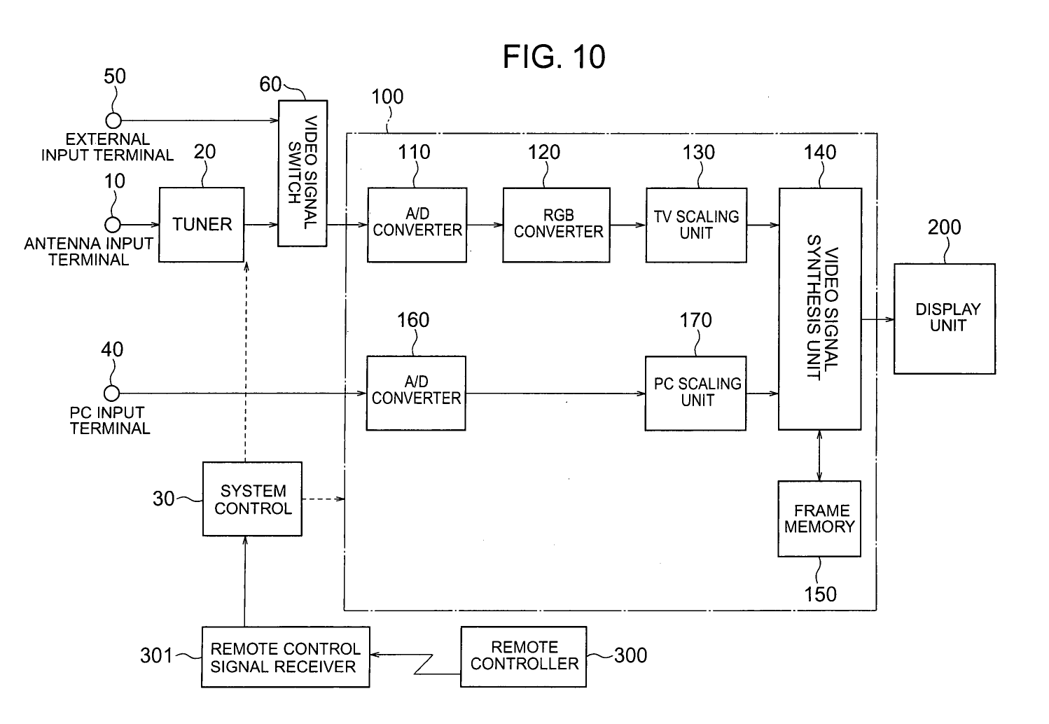

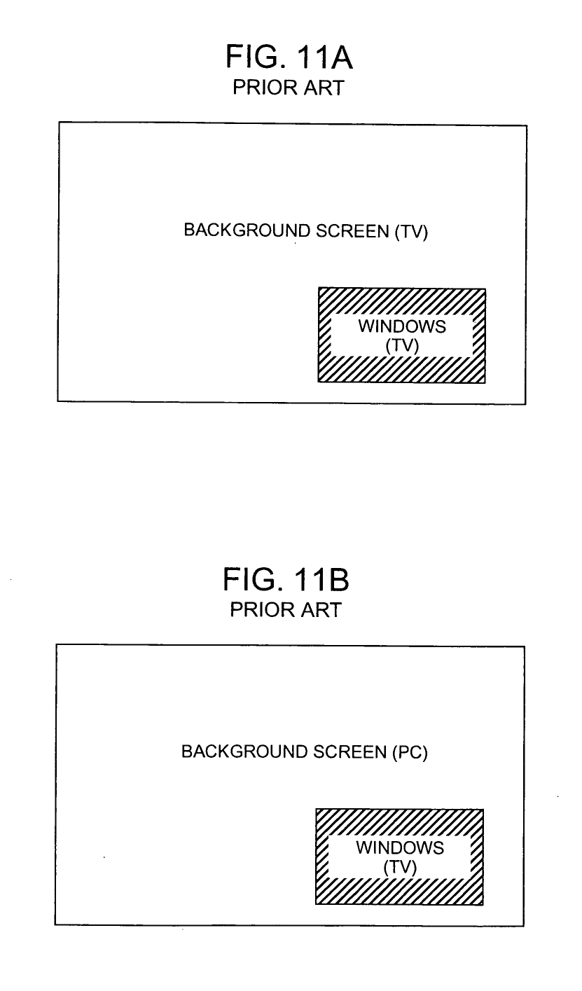

The display device according to the first embodiment of the invention was explained above. FIG. 10 is a block diagram showing the display device according to a second embodiment of the invention, in which an external input terminal 80 and a video signal switching unit 60 are added to the first embodiment of the invention shown in the block diagram of FIG. 1.

The external input terminal 80 is supplied with the TV video signal from the video equipment such as a VTR or a DVD player external to the display device according to the invention. The video signal switching unit 60 operates in response to the instruction from the system control unit 30 in such a manner that the TV video signals supplied from the tuner 20 and the external input terminal 50 are switched to each other and supplied to the A/D converter 110.

By adding the external input terminal 80 and the video signal switching unit 60 as described above, it becomes possible to switch the TV video signals supplied from the tuner 20 and the external input terminal 50 and supply the resultant signal to the A/D converter 110. Thus, the TV video signal supplied from the external input terminal 50 can be processed by the video signal processing unit 100 exactly the same way as the TV video signal supplied from the tuner 20 thereby to display the TV video signal from the external input terminal on the TV small pictures.

Specifically, according to the second embodiment shown in the block diagram of FIG. 10, the user conducting the spreadsheet work or the document composition by operating the mouse or the keyboard of the PC on the PC large picture can simultaneously view a plurality of TV broadcast programs or the contents supplied from the video equipment such as VTR and DVD player connected to the external input terminal 50, without any adverse effect on the particular work (i.e. without deteriorating the workability).

Finally, although the first and second embodiments represent a case having four TV small pictures to facilitate the detailed explanation specifically, the display device according to the invention is not limited to four in the number of TV small pictures but applicable with any number of TV small pictures without departing from the spirit of the invention.

According to this invention, the PC video signal and the TV video signal are arranged and displayed as a PC large picture and a plurality of TV small pictures, respectively, in a manner not superposed with each other. Therefore, the user operating this display device as a TV receiver and a PC monitor at the same time to conduct the spreadsheet job or the document composition with the PC mouse or keyboard on the PC large picture can view the TV broadcast program and the contents supplied from the video equipment external to the display device, without adversely affecting the job efficiency, i.e. the workability at all.

Also, the TV video signal for the TV small pictures is held at the aspect ratio of 4:3 and therefore displayed without any image distortion in horizontal and vertical directions. Thus, the user can view the multiple screens including a PC large picture and TV small pictures displayed with high picture quality.

Further, since a plurality of TV small pictures can be displayed, a plurality of contents can be viewed at the same time.

It should be further understood by those skilled in the art that although the foregoing description has been made on embodiments of the invention, the invention is not limited thereto and various changes and modifications may be made without departing from the spirit of the invention and the scope of the appended claims.

1. A display device for displaying PC (personal computer) video information and TV video information simultaneously, comprising:
a display unit;
a frame memory which stores display information corresponding to a display resolution of said display unit; and
a video signal synthesis unit which is supplied with said PC video information and a plurality of said TV video information, and records the supplied information in areas without superposition in said frame memory, said video signal synthesis unit reading said display information sequentially from said frame memory and outputting said display information to said display unit;
wherein said PC video information and said plurality of said TV video information are displayed in tiles on said display unit.

2. A display device according to claim 1, further comprising:
selected one of a TV scaling unit which changes a resolution of said TV video signal and a PC scaling unit which changes a resolution of said PC video signal;
wherein said video signal synthesis unit is supplied with the video information changed in scale by selected one of said TV scaling unit and said PC scaling unit.

3. A display device according to claim 2,
wherein selected one of said TV scaling unit and said PC scaling unit changes the video information in such a manner as to attain the same display aspect ratio.

4. A display device according to claim 1,
wherein said video signal synthesis unit stores one piece of the PC video information and four pieces of the TV video information in said frame memory, while at the same time storing one of said four pieces of the TV video information periodically in said frame memory.

5. A display device according to claim 1, further comprising:
a remote controller which controls said display device;
wherein said video signal synthesis unit stores one piece of the PC video information and four pieces of the TV video information in said frame memory, while at the same time periodically storing one of said four pieces of the TV video information designated by the remote controller in said frame memory.

6. A display device according to claim 1,
wherein said display unit has a WXGA display resolution and displays the PC video information of the XGA resolution and four pieces of the TV video information having an aspect ratio of 4:3.

7. A display device according to claim 6,
wherein said TV video information is arranged on the left or right side of said PC video information on said display unit longitudinally of said display unit.

8. A display device according to claim 1, further comprising:
a video signal switching unit which selects one of the TV video information and the video information input to said display unit;
wherein the video information selected by said video signal switching unit is recorded in said frame memory.

9. A display device for displaying PC video information and TV video information at the same time, comprising:
a video display unit having an area for displaying the PC video information and an area for displaying a plurality of TV video information, a dynamic image being displayed in any one of said areas for displaying the TV video information; and
a remote controller which inputs designation information for selecting the area for displaying a dynamic area from a plurality of the areas for displaying the TV video information.

10. A multi-screen display control method for synthesizing and displaying a plurality of video information, comprising the steps of:
arranging a plurality of display areas for storing the video information in each frame memory corresponding to each screen in a manner not to be superposed one on another;
recording the PC video information in one of said display areas;
recording the TV video information in a plurality of other display areas different from the display area in which said PC video information is recorded;
outputting the video information recorded in said frame memory; and
renewing the video information in any one of the display areas in which said TV video information are recorded.

11. A multi-screen display control method according to claim 10, further comprising the step of:
selecting a display area for renewing and recording said TV video information.

12. A multi-screen display control method according to claim 11, further comprising the steps of:
inputting an operating instruction of a remote controller;
selecting a display area for renewing and recording said TV video signal based on said operating instruction; and
changing the TV broadcast channel corresponding to said TV video information based on said operating instruction.

13. A multi-screen display control method according to claim 10, further comprising the steps of:
selecting the display area for recording the TV video information at predetermined time intervals; and
recording in said selected display area the TV video information corresponding to the TV broadcast channel determined for each of said plurality of the display areas in said selected display area, and renewing the video information in said display area;
wherein the TV broadcast dynamic image is displayed sequentially in a plurality of other display areas different from the display area where said PC video information is recorded.

14. A multi-screen display control method according to claim 13, further comprising the step of:
maintaining the video information in the display areas other than those where said video information is renewed;
wherein a still image of the TV broadcast immediately before said area change is displayed in the display areas other than said display area for displaying a dynamic image of said video information.

15. A multi-screen display control method according to claim 10, further comprising the steps of:
renewing said TV video information continuously in any one of the display areas for recording said TV video information; and
renewing the TV video information intermittently in the display areas other than said display area.

16. A multi-screen display control method according to claim 15, further comprising the step of:
causing the video information recorded in said display area to correspond to the TV broadcast channel in advance for each display area.

17. A multi-screen display control method according to claim 10, further comprising the steps of:
changing the display area for renewing and recording said TV video information; and
changing the TV video broadcast channel of the video information recorded in said display area, in synchronism with the change of said display area.

18. A multi-screen display control method according to claim 17,
wherein the display area and the TV broadcast channel are changed at predetermined time intervals.

19. A multi-screen display control method according to claim 10, further comprising the steps of:
changing the display area for renewing and recording said TV video information continuously;
renewing the TV video information intermittently in the other display areas than said display area; and
changing the TV broadcast channel corresponding to the TV video information recorded in a plurality of other different display areas than said display area for recording said PC video information when changing said display area.

20. A multi-screen display control method according to claim 19, further comprising the step of:
changing said display area and said TV broadcast channel by remote control operation.
